(19) United States
(12) Patent Application Publication
(10) Pub. No.: US 2011/0208613 A1
(43) Pub. Date: Aug. 25, 2011

(54) Personal shopping buddy shopping cart device

(76) Inventor: Melvin Parham, Perris, CA (US)

(21) Appl. No.: 12/931,473

(22) Filed: Jan. 31, 2011

Related U.S. Application Data
(60) Provisional application No. 61/337,077, filed on Jan. 29, 2010.

(51) Int. Cl. G06Q 30/00; B62M 1/00

(52) U.S. Cl. 705/26.61

(57) ABSTRACT

The Personal Shopping Buddy Shopping Cart Device provides a collapsible shopping cart equipped with state-of-the-art on-board electronics, configured to the needs of the individual user, and capable of digitally linking to the store's database to keep tabs on every item purchased as well as other information. Upon entering the store, the Personal Shopping Buddy automatically links to the store's database and proceeds to download the latest information. Every time the user takes an item from of the shelves, a built-in laser-scanner reads the product's UPC barcode as it is placed into the cart, allowing the system to keep a tab of precisely how much the user spends and exactly what items they are purchasing. The digital LED readout, located on the handle of the cart facing the user, clearly displays the current item count, total price, tax included, as well as other information. Upon exiting, the user is able to easily load the Personal Shopping Buddy into the vehicle merely triggering the pressure-sensitive bumper wheel causing the legs to retract, allowing the unit to slide neatly into the user's trunk, rear seat, or cargo compartment.

### CLAIM OF PRIORITY

This patent application claims priority under 35 USC 119 (e) (1) from U.S. Provisional Patent Application Ser. No. 61/337,077 filed Jan. 29, 2010, of common inventorship herewith entitled, “Personal shopping buddy.”

### FIELD OF THE INVENTION

The present invention pertains to the field of grocery cart devices, and more specifically to the field of digital grocery cart devices.

### BACKGROUND OF THE INVENTION

The prior art has put forth several designs for digital grocery cart devices. Among these are:

U.S. Pat. No. 6,129,274 to Hikaru Suzuki describes an electronic personal shopping system for communicating between a customer's personal memory store and point-of-sale terminals in a retail facility. Demographic profile data, a customer's transaction history data and a customer's current incentive indicia are stored in particular locations in a memory of a portable, machine-readable smart card. The smart card is adapted to interface with a store's check-out terminals and customer assistance, or kiosk terminals.

U.S. Pat. No. 6,435,407 to Luigi Fiordelisi describes a system including a computerized shopping cart that includes a closed mechanical cart which interconnects/disconnects to units for the insertion/storage of products upon manual command managed by a shopping computer aimed at managing shopping problems and controlling all electronic functions, i.e. automatic system for optically scanning bar codes, one for checking the correctness of the customer's operations, one emitting the intelligent multimedia commercial message, one for the wireless exchange of data with the outside, for use in supermarkets.

U.S. Pat. No. 6,484,939 to Dennis C. Blaeuer describes a console for the input and display of consumer product information such as pricing, etc. The console may be built into the handle of the shopping cart or as a retrofit application on existing handles. The console has a product information input device for numerical values such as product pricing, cost per unit, etc. The apparatus has a calculator and output display for such data. Some space on the console will likely be dedicated to a display panel for advertising. The console may be equipped with a bar code scanner as an alternate means of inputting such consumer data. The console should have an output display, such as a monitor, and/or a readout in order to display the product information such as: cost per unit.

U.S. Pat. No. 6,910,697 to Amandakumar Varatharajah and Eric A. Bunn describes an apparatus that assist a shopper during his visit to a merchant store. In one embodiment in the form of a shopping cart, the invention enables a shopper to check himself out of the merchant store. The shopping cart includes a bar-code scanner. The shopping cart rejects non-scanned goods and accepts or rejects scanned goods as directed by the shopper. In another embodiment, the shopping cart includes a web-enabled computer with display. The computer displays product-specific information. The shopping cart computer may detach from the cart—with or without its accessories. The shopper can use the same computer at home to browse the web, to prepare for the shopping trip, to do other transactions. The shopper puts goods in an input bin of the shopping cart. One or more scanners attached to the input bin scan the product for identity. The computer retrieves product-specific information and displays this information on its display. On successful scanning of a product and a display of the product's information, the shopper can accept or reject the product. The product moves into one container in the cart if accepted and moves to a different container in the cart if rejected. On completing shopping, the shopper selects his preferred payment method on the device and pays using the selected method. At the packaging counter, a merchant agent sees an indication that the shopper has paid and, in response, unlocks the cart to remove and pack the goods.

None of these prior art references describe the present invention.

### SUMMARY OF THE INVENTION

It is an object of the present invention to provide a collapsible digital smart grocery shopping cart device.

### BRIEF DESCRIPTION OF THE DRAWINGS

FIG. 1 is an elevational angled perspective view of the device of the present invention.

FIG. 2 is a close-up elevational angled perspective view of a portion of the device of the present invention.

FIG. 3 shows the device of the present invention in its collapsed configuration.

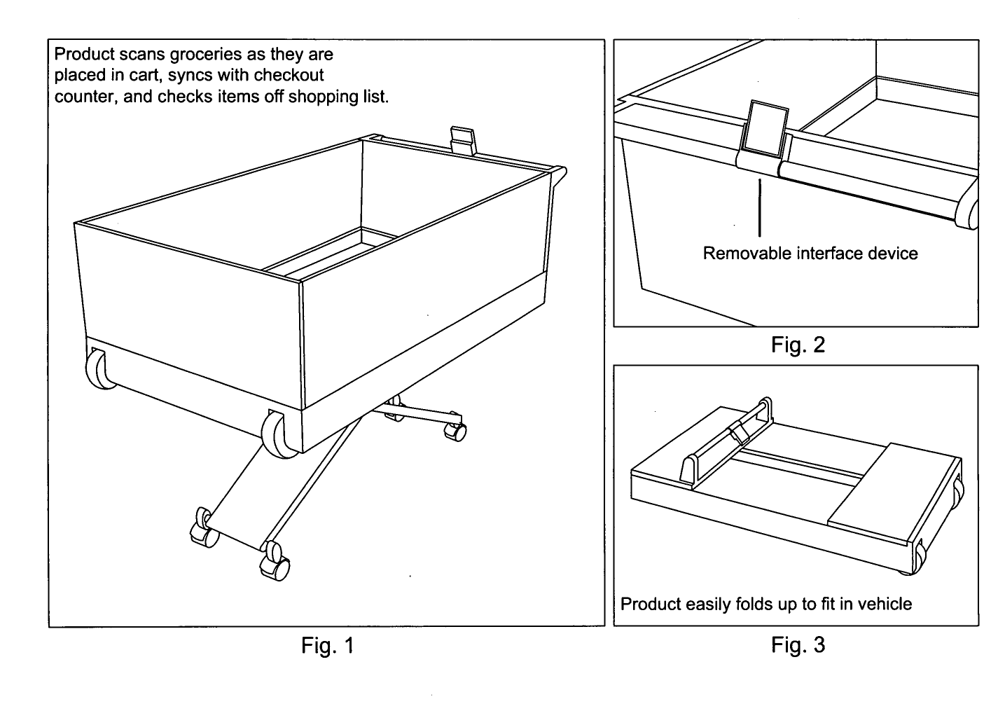

### DETAILED DESCRIPTION OF THE INVENTION

As unbelievable as it may seem, America's vast consumer economy of today, an avid shopper's Heaven on Earth, a land of supermarkets the size of city blocks, discount home stores, and big-box retailers, was brought into being not by the milestone cash register, refrigerated trucks, the credit card or even the computer, as one might first think. Rather, credit for the way we now shop is due primarily to the advent of the shopping cart. That's right, the shopping cart. As America moved out of the Great Depression of the early 1930's, automobiles and electric refrigerators both began to grow larger and more affordable. As such, consumers, now with larger cars and sizable refrigerators, were able to buy, transport, and keep more groceries at home. Unfortunately, the retail businesses themselves, the actual grocery stores, soon found themselves lagging far behind this shifting demographic curve. The once-standard practice of providing shoppers with wire hand-baskets in which to collect their purchases was no longer sufficient, as it limited shoppers' purchases merely to what they could carry, not what they could transport or store. Thus, while consumers had plenty of room in their cars and ample space in their refrigerators, the stores themselves were inadvertently limiting their sales, and what could be significantly larger profit margins, by not keeping up with the bigger, better future. Perceiving this discrepancy in the late 1930's, Sylvan Goodman, the founder of Piggly-Wiggly grocery stores, invented a two-basket “shopping trolley.” And with that one invention, consumers could now collect, buy, and transport drastically larger volumes of groceries and consumer goods from the store to their homes, saving them time, money, and aggravation. In time, Goodman's humble trolley would evolve into the shopping carts we know today. But the rickety, wobbling, perpetually three-wheeled carts we push around the freshly-buffed floors of our local Wal-Marts, Targets and Costco's are nonetheless quite dated. Their basic design has remained virtually unchanged for decades.

The present invention, hereinafter referred as the Personal Shopping Buddy is an ultramodern update to the classical, albeit minimalist design of the traditional shopping cart. Manufactured by the Fabricated Metal Products industry (Standard Industrial Code 3499), in conjunction with the Calculating and Accounting Machines industry (Standard Industrial Code 3578), the Personal Shopping Buddy outwardly resembles, at least in some aspects, most current shopping carts, both having the same rectangular box-like shape and push-handles. The unit measures approximately twenty-four inches to thirty inches in width, forty-two inches in length, including child seat, with height adjustable from twenty-four inches to forty-eight inches and the handle measuring six inches. The significant update is not to the appearance of the cart, however, but rather to its overall function. Unlike regular carts, the legs of the Personal Shopping Buddy are built from collapsible steel rods, allowing the unit to collapse and fit neatly into the trunk of the user's vehicle. The four legs crisscross and slide from a center-mounted pivot-joint, much like an ironing board, permitting them to fold and stow themselves neatly away into a recessed area under the body of the cart. These retractable legs are released via a pressure-sensitive switch underneath the cart, and are fully adjustable to accommodate shoppers of varying heights. Also, the Personal Shopping Buddy features three hundred sixty degree rotating caster-type wheels, enabling the cart to pivot and turn with much more ease and maneuverability than traditional donut-shaped wheels.

What sets the Personal Shopping Buddy miles apart from any other cart currently in use is the fact that this cart is equipped with state-of-the-art on-board electronics, configured to the needs of the individual user, and capable of digitally linking to the store's database to keep tabs on every item purchased as well as providing the user with up-to-the-second information on product pricing, store-wide discounts, nutrition information, health warnings and the like. Upon entering the store, the Personal Shopping Buddy automatically links to the store's database and proceeds to download the latest information. Every time the user takes an item from of the shelves, a built-in laser-scanner reads the product's UPC barcode as it is placed into the cart, allowing the system to keep a tab of precisely how much the user spends and exactly what items they are purchasing. The digital LED readout, located on the handle of the cart facing the user, clearly displays the current item count, total price, tax included, as well as other information the user deems pertinent as the Personal Shopping Buddy is fully customizable to each user's individual preferences. The tracking system allows not only for easier check out, but also helps the user track and monitor their spending habits, making the tiresome task of keeping a budget that much easier. When the user comes to checkout, the once-loathsome process is reduced to a simple momentary transaction, as the items have already been totaled and all coupons have been accounted for. The collected data on the scanner then downloads to a self-check-out register, or a standard register, if the store is compatible, at which time the user swipes his card or pays by cash, and is on his way out the door. Upon exiting, the user is able to easily load the Personal Shopping Buddy into the vehicle merely by pushing the unit toward the trunk or cargo compartment. Upon contact, the pressure-sensitive bumper wheel, with one being located at each of the unit's four corners, is triggered and causes the legs to retract, allowing the unit to slide neatly into the user's trunk, rear seat, or cargo compartment.

The Personal Shopping Buddy, a compact, convenient and space-age way for consumers to streamline the checkout process and enhance their shopping experience, presents a number of distinct benefits and advantages. Foremost, the Personal Shopping Buddy offers users of all sizes, shapes, and physical fitness levels an easier way to do their shopping. The Personal Shopping Buddy is configured to the individual preferences of each user, allowing even physically handicapped users to more easily complete their shopping tasks. By eliminating the need to rely upon clunky traditional carts and replacing them with the Personal Shopping Buddy, consumers are able to keep and store their own personal cart in the trunk of their automobile, and unfold it whenever needed. When shopping was finished, the user simply slides the self-retracting cart back into the trunk, rear seat, cargo compartment or pickup bed. Needless to say, this makes transporting groceries to and from the car much easier and more time-conserving. It is also important to note that in most grocery store chains, one's food and personal items are handled by a multitude of in-store personnel, from stock-boy to cashier to bagger, it seems like everyone has their hands on your items. The Personal Shopping Buddy eliminates this excessive, unnecessary and unsanitary contact by requiring that only the user themselves be the one to touch their items. All of these functions, though, amazing though they are, still pale in comparison next to the Personal Shopping Buddy's state-of-the-art on-board electronics. This is what really sets this invention apart from the pack. By letting the user effortlessly record their spending habits, food purchases, even something as seemingly insignificant as the time of day they went shopping, the Personal Shopping Buddy allows the user to stick to an airtight budget, effortlessly track their diet plans, and view the pattern of their life in a way they never have before. How, when, and where we shop dictates, to some degree at least, who we are in life. The Personal Shopping Buddy allows us a heretofore unprecedented level of accessibility into this historically gray area. Imagine the thrill of walking into a supermarket and immediately knowing exactly which items are on sale, which coupons are most effective, which vegetables are the freshest, even what meat just came in off the truck. Couple this with the added benefit of knowing that you have the absolute latest information regarding health concerns and potential food-scares. The next time spinach is “iffy” or tomatoes are tainted, anyone using the Personal Shopping Buddy is the first to know. Now imagine the thrill of leaving the supermarket and walking to the car, knowing that to load the groceries into your car, all you need to do is push the height-adjusted cart towards the open trunk, and let the bumper-wheel do the rest, watching as the legs fold neatly under the cart as you casually slide the grocery-laden unit inside, a car full of groceries, never having lifted a single bag.

Further, with regard to the burgeoning environmental crisis we face in today's world, the Personal Shopping Buddy does its part to alleviate some of the strain by allowing shoppers to reuse the product innumerable times, possibly eliminating the need for the store to stock fleets of metal shopping carts. This also saves stores money, as they are able to save on man-hours normally spent on care and maintenance for these cumbersome carts. Though perhaps the real saving grace, as far as the environment is concerned, is that no longer do consumers need to rely on the multitude of translucent plastic and brown paper bags that grocery store chains dole out to customers by the millions each year. We stand idly by and watch as the bagboy triple-bags our Funyuns® and wonder why there is an environment problem. The Personal Shopping Buddy lets every shopper simply walk directly out of the store with his or her groceries still in the cart, never having used bag one. The trees that are spared, not to mention the wildlife saved from suffocating or choking on errant plastic bags, make this product not only a great idea for the individual consumer, but for the world, as well.

The Personal Shopping Buddy, an innovative new shopping cart design allowing users to digitally enhance their shopping experience and streamlining once-lengthy checkouts, solves myriad problems concerning environmental and space issues, as well as helping customers track their spending habits and better budget their resources. The product of this invention is the next evolution in shopping carts, not just a cart, but rather a personal, digital shopping assistant.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A collapsible digital smart grocery cart, comprising a rectangular box-like shape and push-handles, wherein the unit measures approximately twenty-four inches to thirty inches in width, forty-two inches in length, including child seat, with height adjustable from twenty-four inches to forty-eight inches and the handle measuring six inches, and wherein the legs of the cart comprise collapsible steel rods, wherein the four legs crisscross and slide from a center-mounted pivot-joint, wherein the retractable legs are released by means of a pressure-sensitive switch mounted underneath the cart, and the legs are fully adjustable, and further wherein the cart comprises three hundred sixty degree rotating caster-type wheels, and further comprising an electronic device, said electronic device capable of digitally linking to the store's database to keep tabs on every item purchased as well as providing the user with current information on product pricing, store wide discounts, nutrition information, health warnings and the like.

2. The device of claim 1, further comprising a digital LED readout, located on the handle of the cart facing the user, wherein the LED readout clearly displays the current item count, total price, tax included, and other information required by the user.

3. The device of claim 2 wherein the collected data on the device can be downloaded to a self-check-out register, or a standard register, if the store is compatible, at which time the user swipes a credit card or pays by cash.

4. The device of claim 1, wherein the device is capable of being easily loaded into a vehicle by pushing the unit toward the trunk or cargo compartment, whereupon contact of a pressure-sensitive bumper wheel is triggered and causes the legs to retract, allowing the device to slide neatly into the user's trunk, rear seat, or cargo compartment.
